(19) United States
(12) Patent Application Publication
(10) Pub. No.: US 2003/0233455 A1
(43) Pub. Date: Dec. 18, 2003

(54) Distributed file sharing system

(76) Inventors: Mike Leber, Fremont, CA (US); Scott Nelson, Castro Valley, CA (US)

Correspondence Address: NATH & ASSOCIATES PLLC, Sixth Floor, 1030 Fifteenth Street, N.W., Washington, DC, 20005, US

(21) Appl. No.: 10/170,632

(22) Filed: Jun. 14, 2002

(51) Int. Cl. G06F 15/173

(52) U.S. Cl. 709/226

(57) ABSTRACT

A distributed file sharing system and a method for providing fast download of data from multiple data storage mediums. The system combines a network of peer client computers which provide data through optimized peer-to-peer communication links, and a server computer which provides an authentication code for checking the completeness and integrity of the downloaded data. The method involves sending a request for a file to the server computer; receiving back from the server an authentication code and a list of peer client computers that have the requested file or part of it; sending a request for the file to a subset of peer clients that yield the fastest download rate; receiving file data back from this subset of peer clients; reassembling the requested file using data sent by the peer clients; and checking the integrity and completeness of the reconstructed file by comparing a computed checksum of said reconstructed file with the authentication code.

### FIELD OF THE INVENTION

This invention relates to distributed file sharing systems and methods of sharing files and more particularly to an Internet based file sharing system and method using peer-to-peer communications between client computers.

### BACKGROUND OF THE INVENTION

The following terms are used in the present application with their following, current commonly accepted meaning.

An “application” or “software application” is a program or group of programs designed for end users. Software can be divided into two general classes: systems software and applications software. Systems software comprises low-level programs that interact with a computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “client”, in the context of the present invention, is a computer that allows a user to communicate with a computer server and to use services provided by the computer server.

A “computer apparatus” is a system that can process information or data and is to be taken very broadly to include a conventional personal computer, a mini computer, a mainframe computer, any microprocessor-driven device such as a hand held or Palm computer, and even a mobile telephone unit that incorporates information or data processing.

A “peer-to-peer” communication system is a system that connects two or more computers of equivalent capabilities and responsibilities in a computer network, allowing for example a direct communication and exchange of data between two personal computers.

A “server”, in the context of the present invention, is a computer apparatus that allows other computers to establish a connection with it, that receives requests for data handling and/or communication procedures, and that performs said data handling and communication procedures accordingly.

The “World Wide Web”, sometimes denoted “WWW” or more simply called the Web, is a sub-set of a world-wide network of computers known as the Internet. The Web is made of all publicly accessible electronic files or documents, also called Web pages, stored in computers connected to the Internet. These Web pages are uniquely identifiable by a Uniform Resource Locator (URL) which is a string of characters that describes the location, name and type of the Web page. Web pages can be grouped in Web sites which are sets of electronic files having a common purpose and that are usually located on a same computer server.

In recent years, with the advent of the Internet and the World Wide Web, the volume of data exchanged over computer networks has increased exponentially, but the infrastructures needed for transporting such a volume of data have not evolved at the same pace. Several systems have been developed to overcome a possible slowing down of data flow due to the ever increasing volume of data transferred through the networks.

Examples of these prior art systems are described in the following U.S. patents and U.S. patent application publications, of which the entire contents are herein incorporated by reference:

U.S. Pat. No. 6,275,470 to Riciulli, U.S. Pat. No. 6,240,429 to Thornton et al., U.S. Pat. No. 6,212,640 to Abdelnur et al., U.S. Pat. No. 6,205,481 to Heddaya et al., U.S. Pat. No. 6,108,703 to Leighton et al., U.S. Pat. No. 6,003,030 to Kenner et al. and U.S. Pat. No. 5,602,853 to Ben-Michael et al.; and

Applic. Pub. No. 2002/0004843 by Andersson et al., Applic. Pub. No. 2002/0004816 by Vange et al., Applic. Pub. No. 2002/0004796 by Vange et al., Applic. Pub. No. 2001/0052008 by Jacobus, Applic. Pub. No. 2001/0044748 by Maier, Applic. Pub. No. 2001/0037311 by McCoy et al. and Applic. Pub. No. 2001/0027467 by Andersson et al.

The Riciulli patent discloses methods and an apparatus for dynamically discovering and utilizing an optimized network path through overlay routing for the transmission of data.

The Thornton et al. patent discloses a document management system that organizes, stores and retrieves documents according to properties attached to the documents.

The Abdelnur et al. patent discloses a method and apparatus for sharing resources in a network environment, wherein a computer linked to the Internet can have resources or can provide services that are usable by other computers.

The Heddaya et al. patent discloses a technique for automatic, transparent, distributed and scalable replication of document copies in a computer network wherein a request message for a particular document follows a path from the client to a home server. Cache servers are located along the path and can intercept the request if they can service it. Cache servers cooperate to update cache content by communicating with neighboring caches.

The Leighton et al. patent discloses a network architecture or framework that supports hosting and content distribution of Web pages on a global scale. The framework allows a content provider to replicate and serve its content at an unlimited number of points. The framework comprises a set of hosting servers operating in a distributed manner. The content provider maintains control over the content by serving the base HTML document of a Web page while the hosting servers serve the embedded objects that compose the Web page.

The Kenner et al. patent discloses a system and method for the optimized storage and retrieval of video data at distributed sites using a deployment of smart mirror sites throughout a network. Each mirror site maintains a copy of certain data managed by the system and every user is assigned to a specific delivery site based on a network performance analysis.

The Ben-Michael et al. patent discloses an apparatus and method for segmentation and reassembly of Asynchronous Transfer Mode packets using only dynamic random access memory as local memory for the reassembly of packets.

The '4843 Andersson et al. published patent application discloses a system, device and method for bypassing detrimental network changes in a communication network by pre-computing recovery paths to protect various primary paths. A fast detection mechanism is used to quickly detect network changes, and communications are switched over from primary paths to recovery paths in order to bypass detrimental network changes.

The '4816 Vange et al. published patent application discloses a method for managing on-network data storage using a communication network. The requests for data from an external client are received by an intermediary server. Units of data are stored in one or more data storage devices accessible to the intermediary server. Information about the specific location of the requested data is retrieved from a storage management server and the intermediary server uses this information to retrieve the data, and then delivers the data to the client that requested it.

The '4796 Vange et al. published patent application discloses a database system operating over a communication network which uses the method disclosed in the '4816 Vange et al. published patent application.

The Jacobus published patent application discloses a method that allows a large number of client applications to communicate through a “many-to-many multicast cloud” over a common carrier such as the Internet to implement groupware configurations including distributed simulations, games and client-controllable data services used to broadcast audio, video or other digital data.

The Maier published patent application discloses a method and system that provides for the search, retrieval and distribution of information to a geographically widely dispersed group of users. The method involves searching a database stored on a remotely located computer connected through the Internet to a Web enabled device.

The McCoy et al. published patent application discloses a distributed architecture where each portion of published content may be divided into numerous small fragments scattered amongst peer systems in a network. Retrieval of data is accomplished by downloading the contents in parallel, locating a replica of an original fragment if a particular peer system serving the original fragment becomes overloaded or disconnected from the network.

The '7467 Anderson et al. published patent application discloses a massively distributed database system and an associated method that utilizes a multitude of widely distributed devices and provides increased data storage capacity and throughput, and decreased latency and cost, compared to existing distributed database architectures.

All these prior art systems rely on a distribution structure in which data is provided to a client computer from one or a plurality of servers through the internet, and on a server-client protocol for downloading the data. Such a distribution structure suffers from one or more of the following conditions. The connection between a client and servers in these prior art systems is a static connection. Data flow speed can become very low when a large number of clients request data simultaneously. In addition, a lengthy download can impair or even incapacitate a particular part of the system for unacceptably long times. A particular server can also become unavailable, thereby rendering at least part of the system inoperable. Files retrieved through one of the prior art systems can also suffer the effects of a bad connection and become corrupted or arrive incomplete at the client computer.

Thus, there is a need for a system that provides a fast and reliable connection, and that allows a client computer to request and download a file from multiple peer client computers with a minimum of dependence on a central server.

There is also a need for a system that allows the client computer to retrieve parts of a file through multiple connections, to reassemble these parts into one file, and to check the validity and completeness of the file.

### SUMMARY OF THE INVENTION

The present invention overcomes the deficiencies of the prior art by providing a distributed file sharing system for fast transfer of data from multiple computer data storage mediums connected by peer-to-peer connections through a computer network.

An advantage of the present invention is the ability to transfer files or parts of files from peer client computers that limits the dependence on a central server computer.

The present invention also provides a system and a method that dynamically select a fastest connection between computers for the transfer of data from peer client computers.

Additionally, the present invention eliminates the requirement for a user to download an entire file from a single source and instead provides a system and a method for the transfer of multiple parts of a file from a plurality of peer client computers, that can be reassembled into one file and checked for completeness and integrity by a predetermined authentication procedure.

The foregoing and other advantages of the present invention are achieved by a system that combines a network of peer clients which provide data through optimized peer-to-peer communication links, and a server which provides an authentication code for checking the completeness and integrity of the downloaded data and can also provide a mapping of the network of peer clients.

In particular, the foregoing and other advantages of the present invention are realized by a system that combines in a very specific embodiment:

a plurality of client computers connected to the computer network;

a plurality of computer data storage mediums connected to a corresponding one of said client computers;

a plurality of client databases containing files or parts of files, each said client database stored on a corresponding one of said computer data storage mediums;

a file retrieval software application operational with each one of said client computers, said file retrieval software application comprising a module that establishes communication links with other ones of said client computers; a module that measures an instantaneous speed of data flow through each one of said communication links and dynamically selects a communication link that yields a highest measured speed of data flow; a module which communicates with said computer data storage medium and which can retrieve a complete file or file part; and a module that reassembles parts of a file into a complete file and that performs a predetermined authentication procedure which computes an authentication code of the file;

a server computer connected to the computer network and connectable to each of said client computers;

a server computer storage medium connected to said server computer;

a server database stored on said server computer storage medium, said server database containing said list of files and said lists of locations of client computers associated with each one of said files; and

a file sharing software application operational with said server computer which maintains a list of files that are stored on client databases and a list of locations of client computers that store said files, which also computes an authentication code of a file, and which sends said authentication code and said locations of client computers to a client computer that requests the file.

### BRIEF DESCRIPTION OF THE DRAWINGS

FIG. 1 is a schematic diagram illustrating a network of peer client computers and their associated storage mediums, connected to each other and to a server computer through a global network according to an embodiment of the present invention.

FIG. 1a is a schematic block diagram depicting the computer program modules of the File Retrieval Software Application.

FIG. 2 is a schematic block diagram illustrating a sequence of steps performed to request and download a file according to a first embodiment of the present invention.

FIG. 3 is a schematic block diagram illustrating a sequence of additional steps performed to download a file when the sequence shown in FIG. 2 yields an incomplete result, according to the first embodiment of the present invention.

FIG. 4a is a schematic block diagram illustrating a first part of a sequence of steps performed to request and download a file according to a second embodiment of the present invention.

FIG. 4b is a schematic block diagram illustrating a second part of a sequence of steps performed to request and download a file according to the second embodiment of the present invention.

FIG. 5 is a schematic flow diagram of a computer program illustrating the flow of information, and tests performed in a file sharing software application of a distributed file sharing system according to the present invention, from a server point of view.

FIG. 6 is a schematic flow diagram of a computer program illustrating the flow of information, and tests performed in a file retrieval software application of a distributed file sharing system according to the present invention.

FIG. 7 is a schematic flow diagram of a computer program illustrating the flow of information, and tests performed in a file sharing software application of a distributed file sharing system according to the present invention, from a serving peer client point of view.

### DETAILED DESCRIPTION OF THE PREFERRED EMBODIMENT

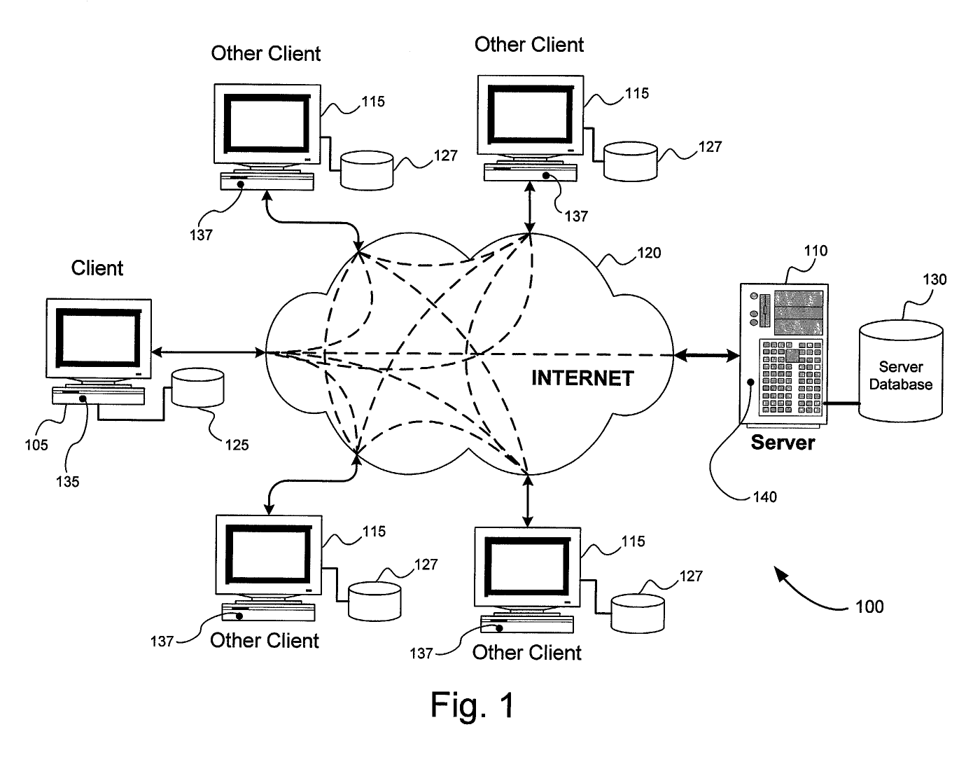

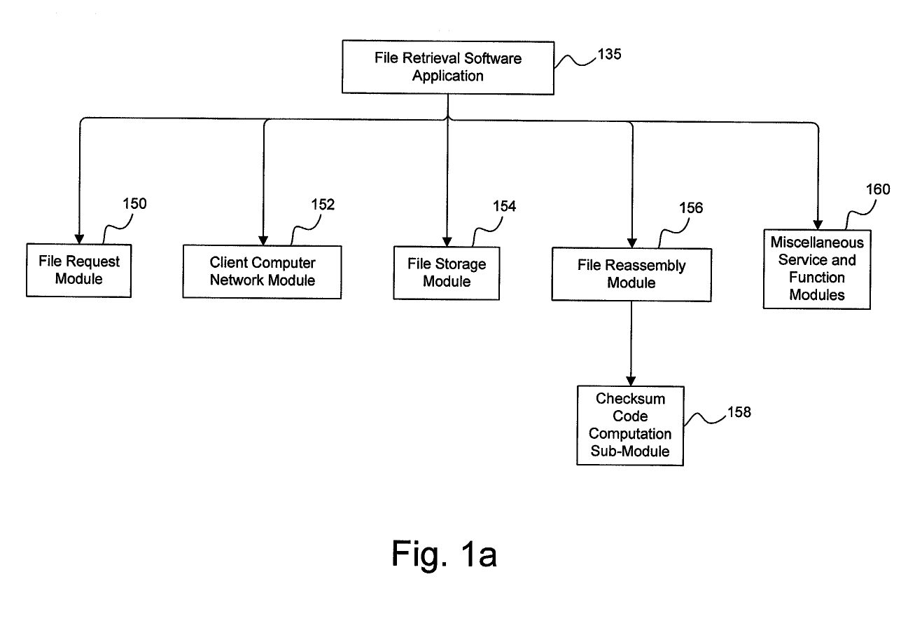

With reference now to the figures wherein like elements have the same number throughout the several views, and in particular with reference to FIG. 1, a file sharing system 100 comprised of a combination of software applications, computers and communication networks according to a presently preferred embodiment of the present invention is depicted.

File sharing system 100 is comprised of a client computer 105, a server computer 110, a plurality of other client computers 115, sometimes also called peer client computers 115, and a global computer network 120 such as the Internet. A preferred connection method for client-server and peer-to-peer communication is TCP/IP, i.e. “Transmission Control Protocol/Internet Protocol” over the Internet. However, other IP protocols such as UDP (User Datagram Protocol), or EIA (Electronic Industries Alliance) approved connection standards such as RS-232 or RS-485, or even switch phone networks could be used for client-server and peer-to-peer communication.

Client computer 105 and peer client computers 115 are conventional computer apparatuses comprising an input/output interface, a memory for storage of data and programs and a Central Processing Unit (CPU) that can execute the programs.

A preferred protocol for peer to peer communication is HTTP, i.e. HyperText Transfer Protocol, which is a conventional transfer protocol used to transfer Web pages over the Internet. However, any file transfer protocol such FTP (File Transfer Protocol), Gopher, or any other similar protocol could be used.

In a presently preferred embodiment of the invention, server computer 110 is a conventional UNIX workstation equipped with a Hard Disk, Random Access Memory and a Central Processing Unit (CPU) (all not shown). However, any server workstation, or even a minicomputer or mainframe computer could be used.

A custom client to server transfer protocol with special optimizations for communicating information is used in the preferred embodiment of the present invention. However, any file transfer protocol such FTP, Gopher, or any other similar protocol could be used.

A plurality of individual data storage mediums 125 and 127, sometimes also called individual databases 125 and 127, are respectively connected to corresponding ones of client computer 105 and each peer client computer 115. Storage medium 125 and storage mediums 127 all contain shared files, or parts of shared files to be distributed and information about the contents of the files and locations of the files associated with each other peer client computer 115. However, each storage medium 125 and 127 also contains different files particular to its respective computer. Also, each storage medium 125 and 127 need not contain all of the files and parts of the files to be distributed which are contained on other storage mediums 125 and 127.

In a presently preferred embodiment of the invention, data storage medium 125 and data storage mediums 127 can be different models or the same model of a conventional non-volatile or volatile memory. Such memory can be physically installed inside computers 105 and 115 (e.g. conventional installed or removable hard disks), can be directly attached to each computer, or can be standalone memories directly connected or network connected to the respective computer 105 and 115.

A preferred database system for the individual database connected to each client computer 105 and 115 is the native file system of an operating system run by the client computer. This native file system can be for example the Linux file system. However, other database systems could be used, such as MySQL, NFS or DBASE.

A server database or data storage medium 130 is connected to server computer 110. Data storage medium 130 contains a database, which in turn contains information about the locations in the network of client computers 105 and 115, the contents associated with each client computer, and authentication codes associated with each file or part of file stored on the individual storage mediums 125.

In a preferred embodiment of the present invention server database 130 is a Linux file system, which is a Unix-like file system that is part of the operating system that runs the server. However, other databases could be used, such as MySQL (where SQL stands for Structured Query Language), NFS (Network File System), DBASE or any other commercially available database management system.

A file retrieval software application 135 is stored in the memory of client computer 105 and can be executed by the CPU of client computer 105. Similar or identical file retrieval software applications 137 are stored in their respective client computers 115. Thus a description of software application 135 is also a description of software application 137.

A file sharing software application 140, stored on the hard disk of server computer 110, contains computer program code that can receive a request for software, and the CPU of server computer 110 can execute the request.

With reference now to FIG. 1a, file retrieval software application 135 comprises a file request module 150, a client computer network module 152, a file storage module 154, a file reassembly module 156 connected to a checksum code computation sub-module 158, and miscellaneous service and function modules 160. Module 150 contains computer program code that can send a request for a file to server computer 110 through Internet 120 (FIG. 1). File sharing software application 140 comprises a module that contains computer program code that can send a query to server database 130 and can retrieve a list of possible serving client computers 115 that have a copy of the requested file or part of the file stored in their individual database 127. File sharing software application 140 contains computer program code that also can compute an authentication code for the requested file and for each part of the file stored in individual database 125 and individual databases 127, and send the authentication code for the requested file and the list of possible serving client computers back to client computer 105.

File retrieval software application 135 also can receive a list of possible serving client computers 115 that contain all or a part of the requested file and can send a request for a desired file to each peer client computer on the list of possible serving client computers 115. As stated above, each peer client computer 115 has a similar file retrieval software application 137 which can access an individual database 127.

When a file request is received by software application 137 from another peer client computer, software application 137 transmits that file or part of the file to client computer 105. File retrieval software application 135 contains computer program code that reassembles a single complete file using the received files or received parts of files. Software application 135 can also check the completeness and integrity of the reassembled file using an authentication code it can receive from server computer 110.

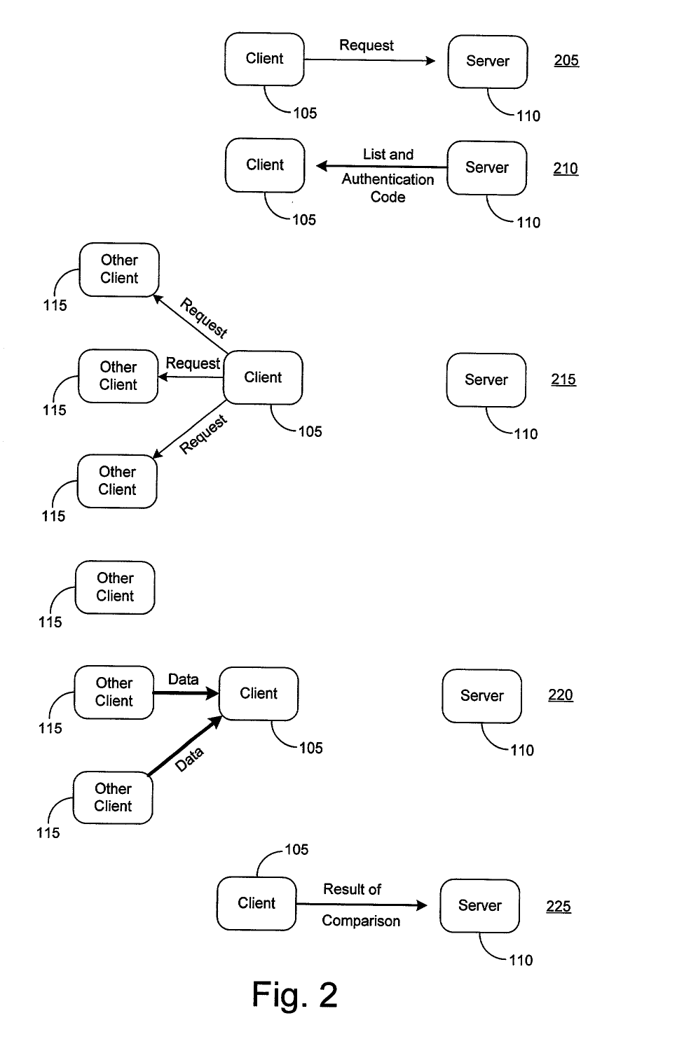

A first example of a method of using an embodiment of file sharing system 100, in which a server computer is a main repository of information, is depicted as a flow of events depicted in FIG. 2.

In particular, FIG. 2 depicts the association and inter relationship of elements of a distributed file sharing system as a series of steps. According to a first embodiment of the invention, a first step 205 of a method of using file sharing system 100 comprises a request for a file sent by a requesting client computer (denoted only “client” in FIG. 2) to a server computer (denoted only “server” in FIG. 2) through a computer network.

A second step 210 comprises a response sent by the server computer to the requesting client computer. This response is comprised of a list of other client computers that presumably have a copy of the requested file, and of an authentication code corresponding to the requested file.

In a third step 215 the requesting client computer attempts to connect to one or more other client computers, also called peer client computers, on the list sent by the server computer, and sends a request for the file or a particular part of the file to each peer client computer. Server 110 is inactive during this step.

In a fourth step 220, the peer client computers which have the requested file or a file part send file data back to the requesting client computer. These file data can be a whole copy of the file or a part of the file. The requesting client computer uses these file data to reconstruct a single, complete file. Server 110 remains inactive during this step and one peer client computer which does not have the requested file (or cannot send it) sends nothing, which assumes that the list sent by the server is not up to date.

In a fifth step 225, the requesting client computer computes a checksum of the reconstructed file according to a predetermined algorithm and compares the resulting checksum with the authentication code sent by the server computer. The result of the comparison is sent back to the server computer. If the resulting checksum matches the authentication code, then the reconstructed file is qualified as complete and correct. If the resulting checksum does not match the authentication code, then the reconstructed file is qualified as incomplete or corrupted.

In a preferred embodiment of the present invention the integrity and completeness of a file or parts of a file are checked using a checksum algorithm called MD5, i.e. “Message Digest 5” which is a publicly available open source checksum algorithm developed by Professor Ronald L. Rivest of the Massachusetts Institute of Technology. However, any other similar algorithm such as SHA1 (Secure Hash Algorithm 1) or CRC (Cyclic Redundancy Checking), or even a simple additive checksum could be used.

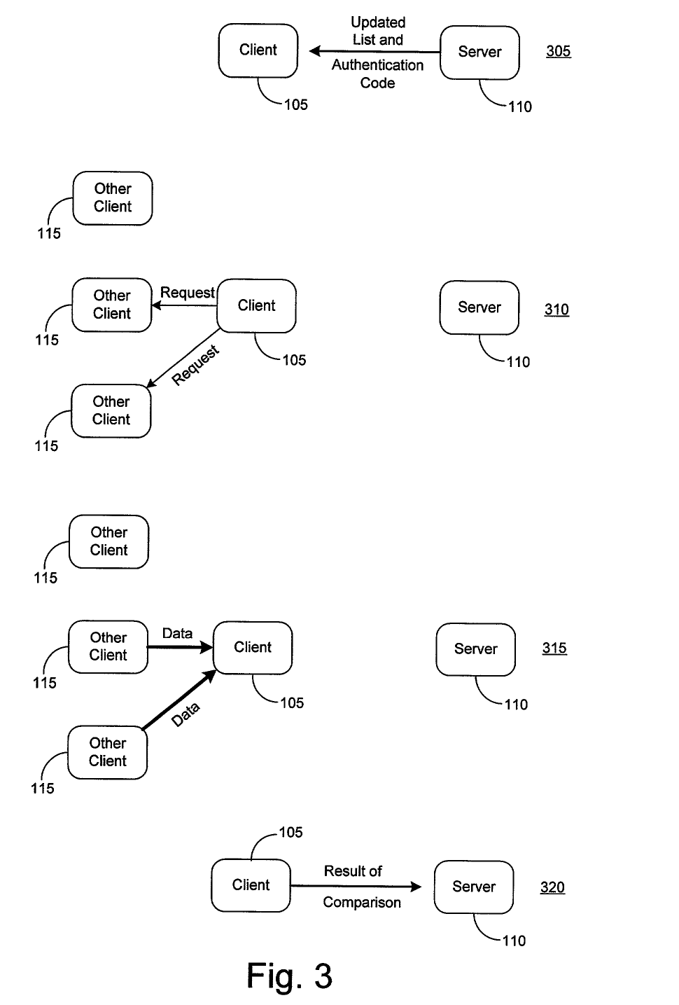

With reference now to FIG. 3, a process flow is depicted describing elements of a distributed file sharing system according to a first embodiment of the invention, and a method of using said distributed file sharing system in a case where a first series of steps described in FIG. 2 yields a checksum code that does not match the authentication code sent by the server computer, i.e. in a case where the reconstructed file is incomplete or corrupted.

In a first step 305, server computer 110 sends a new and updated list of possible peer client computers to the requesting client computers that presumably have a copy of the requested file, and an authentication code.

In a second step 310, the requesting client computer contacts the peer client computers on the list provided by the server computer, and omits for example a peer client computer that failed to provide appropriate data in a previous attempt.

In a third step 315, the peer client computers that have a copy of the requested file or part of it, send file data back to the requesting client computer, and the requesting client computer uses these data to reconstruct a single, complete file.

In a fourth step 320, the requesting client computer computes again a checksum of the reconstructed file according to the predetermined algorithm and compares the resulting checksum with the authentication code sent by the server computer. The result of the comparison is again sent back to the server computer.

Steps 305-320 are repeated until the reconstructed file is qualified as complete and correct.

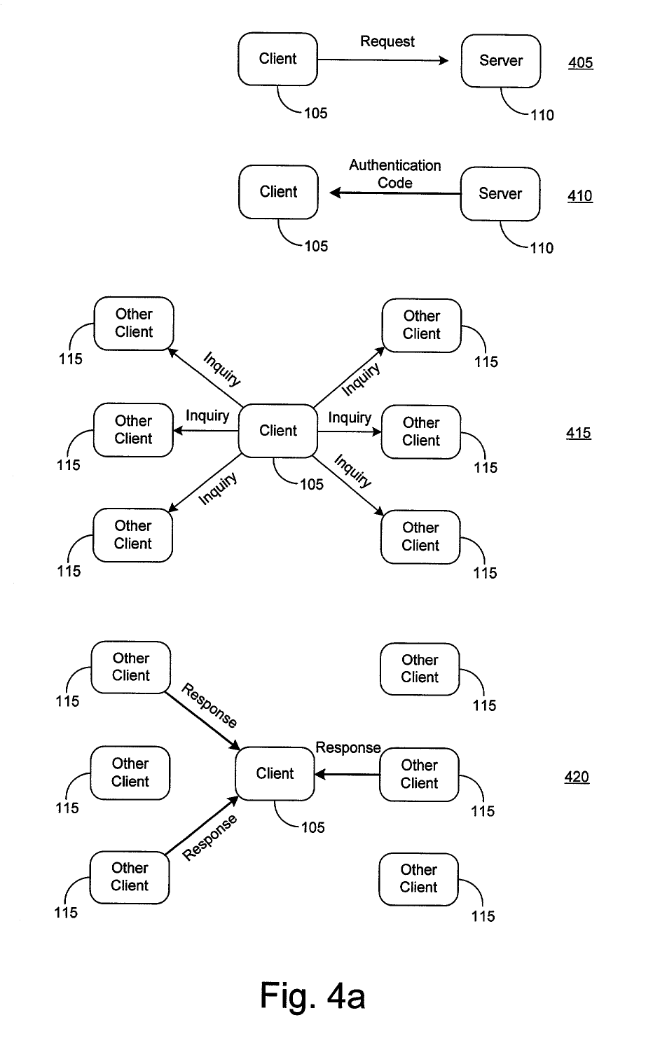

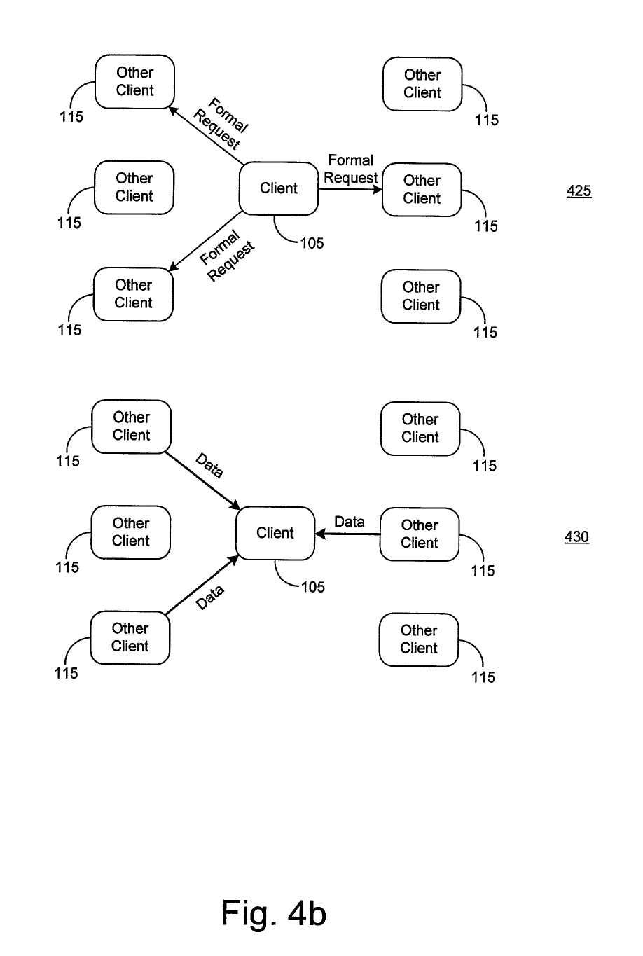

With reference now to FIG. 4a and FIG. 4b, a process flow is depicted describing elements of a distributed file sharing system according to a second embodiment of the invention, and a method of using said distributed file sharing system wherein each peer client computer is a main repository of information. According to this second embodiment of the invention, a first step 405 of the method comprises a request for a file sent by a requesting client computer 105 to a server computer 110 through a computer network 120.

A second step 410 comprises a response sent by the server computer to the requesting client computer. This response is comprised of an authentication code corresponding to the requested file.

In a third step 415 the requesting client computer attempts to connect to one or more other client computers, also called peer client computers, selected from a list of peer client computers stored in an individual database 125 connected to the requesting client computer. The list of peer client computers that are actually solicited by the requesting client computer is based on the “network distance” to said peer client computers. The network distance in the context of the present invention is a parameter that characterizes the speed of data flow between a peer client computer and the requesting client computer, a higher speed of data flow corresponding to a lower network distance. The requesting client computer sends a message to each chosen peer client computer and asks whether or not they have a copy of the file or part of the file.

A preferred method to measure “network distance” is to time the responsiveness of a channel during a download. However, other methods could be used such as determination of a number of “hops”, i.e. intervening routers on a path, determination of a cost as measured by BGP (Border Gateway Protocol) routing tables, or even user supplied data or pre-configured network topology maps.

In a fourth step 420, the peer client computers that actually have a copy of the requested file, or part of it, send a positive response to the requesting client computer.

In a fifth step 425 (see FIG. 4b), the requesting client computer sends a formal request for the file or part of the file to the peer client computers that sent a positive answer in step 420.

In a sixth step 430, the peer client computers that have a copy of the requested file, or part of it, send the requested file data back to the requesting client computer. The requesting client computer uses these data to reconstruct a single, complete file, and computes a checksum code of the reconstructed file according to a predetermined algorithm and compares the resulting checksum code with the authentication code sent by the server computer in step 410. If the resulting checksum code matches the authentication code, then the reconstructed file is qualified as complete and correct. If the resulting code does not match the authentication code, then the reconstructed file is qualified as incomplete or corrupted.

Steps 405-430 are repeated until the reconstructed file is qualified as complete and correct.

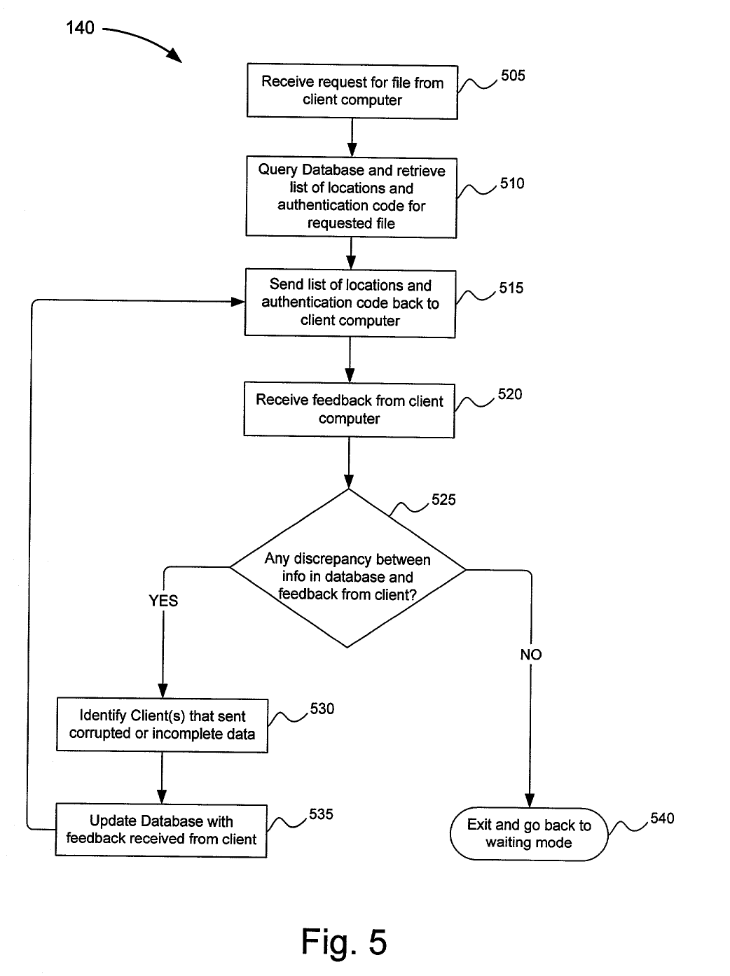

With reference now to FIG. 5, there is depicted a schematic flow diagram representing the processes and information flow in a file sharing software application 140 (see FIG. 1) run by a server computer 110 according to the first embodiment of the present invention.

A request for a file is received from requesting client computer 105 (FIG. 1) at interface 505. Interface 505 is connected to a process box 510 that sends a query to database 130 (FIG. 1) and retrieves a list of locations of peer client computers 115 (FIG. 1) that presumably have a copy of the requested file or part of the file stored in their individual database, and an authentication code associated with the requested file.

Process box 510 is connected to a module 515 that sends the list of locations and the authentication code back to client computer 105. Module 515 is in turn connected to an interface 520 that receives a feedback message from client computer 105 after client computer 105 has attempted to retrieve and reassemble the requested file. This feedback message comprises a confirmation list of peer clients that were actually able to provide data relative to the requested file. The feedback message also comprises a checksum code computed by client computer 105, based on a reconstructed copy of the requested file. If client computer 105 determines that the reconstructed copy of the requested file is corrupted or incomplete, then the feedback message also comprises checksum codes computed by client computer 105 for each part of the requested file sent by peer client computers 115.

The checksum code of the reconstructed file is used by a decision box 525 which compares it to the server-provided authentication code that was sent by module 515. If there is a discrepancy between the checksum code and the server-provided authentication code, then software application 140 branches to a module 530 which computes a server-generated checksum code for each part of the file that was sent to client computer 105. These server-generated checksum codes are compared with the checksum codes sent by client computer 105 in the feedback message, and are thereby used to identify the peer client (or clients) that sent an incomplete or corrupted part of the requested file to client computer 105.

Module 530 is connected to a process box 535 which updates database 130 using information from the feedback message, and returns to module 515 to start a new loop comprising: sending a list of locations of peer client computers 115 and an authentication code; receiving a feedback message from client computer 105 at interface 520; and comparing the checksum code to the authentication code that was sent by module 515.

If there is no discrepancy between the checksum code and the authentication code, then software application 140 branches to a command 540 which halts the software application and puts computer server 110 back into a waiting mode and ready to receive a new request for a file from a client computer.

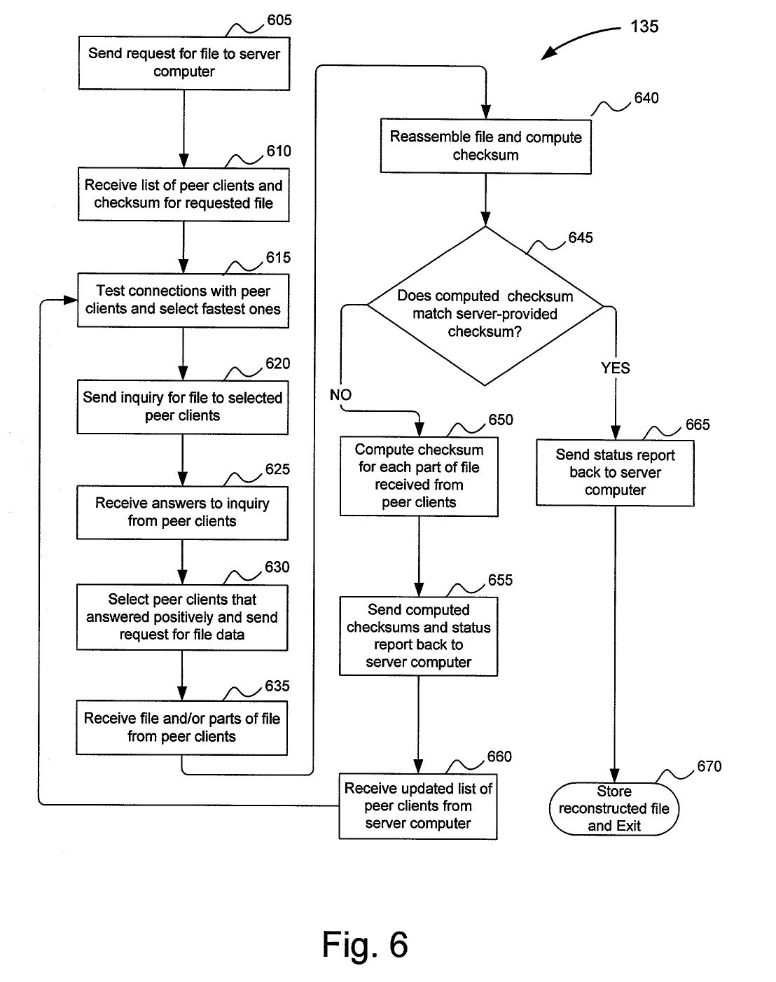

With reference now to FIG. 6, there is depicted a schematic flow diagram representing the processes and information flow in a file retrieval software application 135 (see FIG. 1 and FIG. 1a) run by a requesting client computer 105 according to the first embodiment of the present invention.

A request for a file is sent to server computer 110 (as shown in FIG. 1) by an interface 605. Interface 605 is connected to a module 610 which receives a list of peer client computers 115 (FIG. 1) and an authentication code, sometimes also called checksum code, from server computer 110.

The list of peer client computers received by module 610 is used by a subroutine 615 which tests a set of possible connections between requesting client computer 105 and the peer client computers listed in the list sent by server computer 110. Subroutine 615 selects a subset of peer client computers yielding the fastest data flow, i.e. presenting the shortest “network distance” from requesting client computer 105, and provides this subset to a module 620.

Module 620 sends a message to the subset of peer client computers selected by subroutine 615. This message comprises an inquiry about the requested file. Any peer client computer that receives the message and actually has a copy of the requested file, or part of it, sends a positive response to requesting client computer 105.

These responses are received by a module 625 and transmitted to a module 630. Module 630 collects a list of peer client computers that responded positively to the inquiry send by module 620 and sends to each of these peer client computers a formal request to retrieve at least a part of the requested file.

The parts of file sent by the peer client computers that responded positively to the inquiry sent by module 620 are received by a module 635 which transmits said parts of file to a subroutine 640.

Subroutine 640 uses the parts of file received from module 635 to reconstruct a single complete copy of the requested file, and computes a checksum code of the reconstructed file according to a predetermined algorithm. This checksum code and a status report on the peer client computers that were contacted by subroutine 615, are transmitted to a decision box 645 which compares the checksum code computed by subroutine 640 to the authentication code sent by server computer 110.

If the checksum code matches the authentication code, then the reconstructed file is qualified as complete and correct, and is treated as described hereinbelow.

If decision box 645 yields a negative answer, i.e. if the reconstructed file is incomplete or corrupted, then the program branches to a module 650 which computes a checksum code for each part of the requested file received from peer clients 115 by client computer 105. These checksum codes are transmitted to a module 655 which sends said checksum codes, along with the checksum code of the whole reconstructed file and a status report on the peer clients that were actually contacted, to server computer 110 for diagnostic purposes.

The program then branches to a module 660 which receives an updated list of peer clients from server computer 110, and loops back to subroutine 615 to test the connections with the peer clients of the updated list sent back by server computer 110.

Modules 615-645 are repeated until the reconstructed file is qualified as complete and correct, in which case decision box 645 branches to a module 665 which sends a status report back to server computer 110 and then branches to a command 670 which stores the reconstructed file on requesting client computer 105 and halts the file retrieval software application.

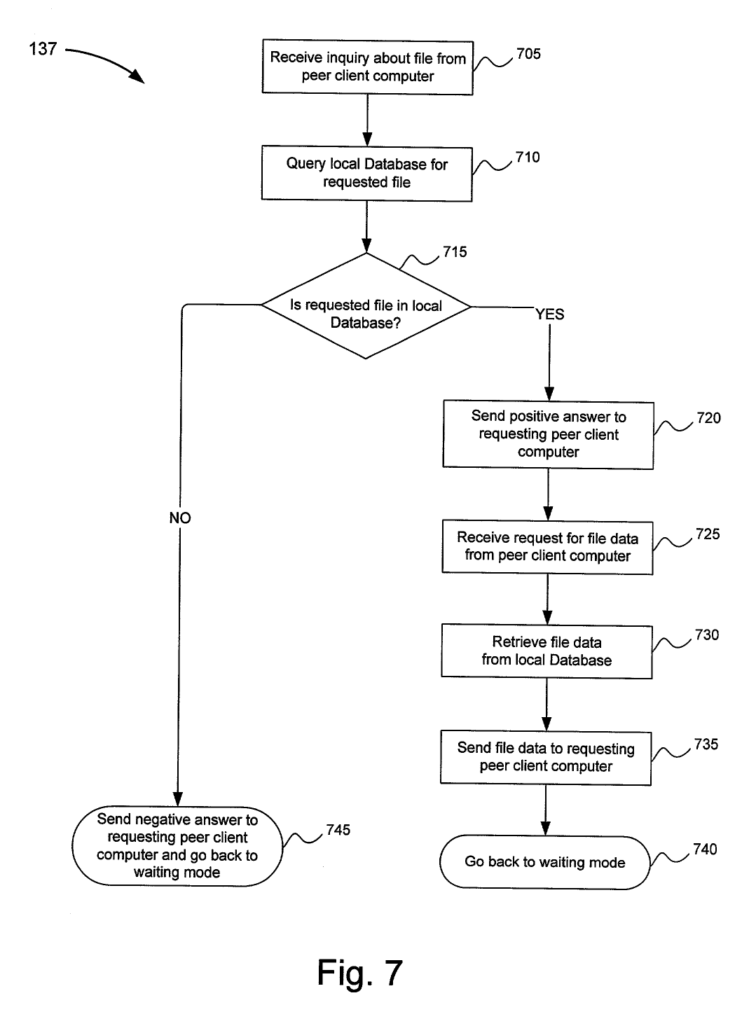

With reference now to FIG. 7, there is depicted a schematic flow diagram representing the processes and information flow in a file sharing software application 137 run by a serving peer client computer 115 according to an embodiment of the present invention.

A inquiry about a file is received from requesting peer client computer 105 (as shown in FIG. 1) at interface 705. Interface 705 is connected to a process box 710 that sends a query to individual database 125 (FIG. 1) to check whether or not a copy of the requested file, or part of it, is stored in individual database 125. An output from database 125 is then received by process box 710 which sends it to a decision box 715.

If a copy of the requested file, or part of it, is stored in individual database 125, then decision box 715 branches to a module 720 which sends a positive response to requesting client computer 105. A formal request for a whole copy or a part of the requested file is received by a module 725 which transmits the request to a subroutine 730 that retrieves the requested data from individual database 125.

Subroutine 730 transmits the requested data to a module 735 which sends said data back to requesting peer client computer 105.

Module 735 is connected to a command 740 which halts the file sharing software application and puts the serving peer client computer back into a waiting mode and ready to receive a new request for a file from a peer client computer.

If there is no copy of the requested file, or a part of it, in individual database 125, then decision box 715 branches to a module 745 which sends a negative response to requesting client computer 105, halts the file sharing software application and puts the serving peer client computer back into a waiting mode and ready to receive a new request for a file from a peer client computer.

In use, distributed file sharing system 100 is populated and/or updated with new files to be downloaded in a progressive, geometrically expanding manner. When a file is ready to be shared, a first set of copies of the file can be placed on storage mediums connected to an initial cluster of servers. A first wave of clients that send a request for the file can download the file from one or more servers of the initial cluster of servers. The requesting clients of the first wave that have downloaded the file can in turn act as serving clients and serve the file to other requesting clients. A second wave of clients that send a request for the file can then download the file from clients of the first wave of clients. With each new wave of requesting clients that download the file, the number of clients that can serve the file expands geometrically. A simple calculation can show how this system can improve the speed of distribution of a file within a network of computers, without requiring any significant increase of bandwidth of communication between computers.

In a preferred embodiment of the present invention the client/server relationship is that of a subscription model in which the client pays the server for a service. However, other types of relationships could be possible, including a relationship in which the server pays the client for being part of a network and storing data on behalf of the server, or a relationship in which an exchange of data is free, or even a relationship which is subsidized by a separate party such as advertising.

Although only a few exemplary embodiments of the present invention have been described above, it will be appreciated by those skilled in the art that many changes may be made to these embodiments without departing from the principles and the spirit of the invention.

What is claimed is:

1. A distributed file sharing system for fast download of data from multiple computer data storage mediums connected by peer-to-peer connections through a computer network comprising, in combination:
a plurality of client computers connected to the computer network;
a plurality of computer data storage mediums connected to a corresponding one of said client computers;
a plurality of client databases, each said client database stored on a corresponding one of said computer data storage mediums, and containing files or parts of files;
a file retrieval software application operational with each one of said client computers, said file retrieval software application comprising a module that establishes communication links with other ones of said client computers; a module that measures an instantaneous speed of data flow through each one of said communication links and dynamically selects a communication link that yields a highest measured speed of data flow; a module which communicates with said computer data storage medium and which can retrieve a complete file or file part; and a module that reassembles parts of a file into a complete file and that performs a predetermined authentication procedure which computes an authentication code of the file;
a server computer connected to the computer network and connectable to each of said client computers;
a server computer storage medium connected to said server computer;
a server database stored on said server computer storage medium, said server database containing said list of files and said lists of locations of client computers associated with each one of said files; and
a file sharing software application operational with said server computer which maintains a list of files that are stored on client databases and a list of locations of client computers that store said files, which also computes an authentication code of a file, and which sends said authentication code and said locations of client computers to a client computer that requests the file.

2. A distributed file sharing system as claimed in claim 1 wherein the computer network is a global computer network such as Internet.

3. A distributed file sharing system as claimed in claim 2 wherein the peer-to-peer connections comprise a TCP/IP protocol over the Internet.

4. A distributed file sharing system as claimed in claim 2 wherein the peer-to-peer connections comprise a UDP protocol.

5. A distributed file sharing system as claimed in claim 2 wherein the peer-to-peer connections comprise a RS-232 connection standard.

6. A distributed file sharing system as claimed in claim 2 wherein the peer-to-peer connections comprise a RS-485 connection standard.

7. A distributed file sharing system as claimed in claim 2 wherein the peer-to-peer connections use a switch phone network.

8. A distributed file sharing system as claimed in claim 3 further comprising a client-server connection which uses a TCP/IP protocol over the Internet.

9. A distributed file sharing system as claimed in claim 3 further comprising a client-server connection which uses a UDP protocol.

10. A distributed file sharing system as claimed in claim 3 further comprising a client-server connection which uses a RS-232 connection standard.

11. A distributed file sharing system as claimed in claim 3 further comprising a client-server connection which uses a RS-485 connection standard.

12. A distributed file sharing system as claimed in claim 3 further comprising a client-server connection which uses a switch phone network.

13. A distributed file sharing system as claimed in claim 8 further comprising a peer-to-peer communication protocol wherein said peer-to-peer communication protocol is a HTTP protocol.

14. A distributed file sharing system as claimed in claim 8 further comprising a peer-to-peer communication protocol wherein said peer-to-peer communication protocol is a FTP protocol.

15. A distributed file sharing system as claimed in claim 13 further comprising a client-to-server communication protocol wherein said client-to-server communication protocol is a customized communication protocol which is optimized for the client-server connection.

16. A distributed file sharing system as claimed in claim 13 further comprising a client-to-server communication protocol wherein said client-to-server communication protocol is a FTP protocol.

17. A distributed file sharing system as claimed in claim 15 wherein said predetermined authentication procedure comprises a MD5 checksum algorithm.

18. A distributed file sharing system as claimed in claim 15 wherein said predetermined authentication procedure comprises a SHA1 checksum algorithm.

19. A distributed file sharing system as claimed in claim 15 wherein said predetermined authentication procedure comprises a CRC checksum algorithm.

20. A distributed file sharing system as claimed in claim 17 wherein said instantaneous speed of data flow is measured by a module which times a responsiveness of a channel during a download.

21. A distributed file sharing system as claimed in claim 17 wherein said instantaneous speed of data flow is measured by a module which determines a number of intervening routers on a path.

22. A distributed file sharing system as claimed in claim 17 wherein said instantaneous speed of data flow is measured by a module which determines a cost as measured by Border Gateway Protocol routing tables.

23. A distributed file sharing system as claimed in claim 17 wherein said instantaneous speed of data flow is determined by a module which uses pre-configured network topology maps.

24. A distributed file sharing system as claimed in claim 20 wherein said server computer is a workstation that runs a UNIX-like operating system.

25. A distributed file sharing system as claimed in claim 20 wherein said server computer is a workstation that runs a Linux operating system.

26. A distributed file sharing system as claimed in claim 24 wherein said server database is a Linux file system.

27. A distributed file sharing system as claimed in claim 24 wherein said server database is a SQL-compatible database.

28. A distributed file sharing system as claimed in claim 24 wherein said server database is a MySQL database.

29. A distributed file sharing system as claimed in claim 24 wherein said server database is a Network File System database.

30. A distributed file sharing system as claimed in claim 24 wherein said server database is a DBASE database.

31. A distributed file sharing system as claimed in claim 26 wherein said client database connected to a client computer is a native file system of an operating system run by said client computer.

32. A distributed file sharing system as claimed in claim 26 wherein said client database conneted to a client computer is a Linux file system.

33. A distributed file sharing system as claimed in claim 26 wherein said client database connected to a client computer is a SQL-compatible database.

34. A distributed file sharing system as claimed in claim 26 wherein said client database connected to a client computer is a MySQL database.

35. A distributed file sharing system as claimed in claim 26 wherein said client database connected to a client computer is a Network File System database.

36. A distributed file sharing system as claimed in claim 26 wherein said client database connected to a client computer is a DBASE database.

37. A method of using a distributed file sharing system for fast download of data from multiple computer data storage mediums connected by peer-to-peer connections through a computer network, said method comprising the steps of:
sending a request for a file from a client computer connected to the computer network to a server computer connected to the computer network;
receiving a response from the server computer through the computer network, said response comprising a list of locations of other client computers that presumably have said file, or a part of said file, and an authentication code corresponding to said file;
sending a query for the file to a pre-selected set of other client computers;
receiving a response from a subset of other client computers that actually have the file or a part of the file;
sending a formal request for the file to the subset of other client computers that actually have the file or a part of the file;
receiving data pertaining to the file or a part of the file from the subset of other client computers that actually have the file or a part of the file;
reassembling the file using the data received from said subset of other client computers;
computing a checksum of a reassembled file and performing a comparison between said checksum and the authentication code received from the server computer;
sending a status report comprising the comparison between the checksum and the authentication code back to the server computer.

38. A method of using a distributed file sharing system as claimed in claim 37 further comprising the steps of measuring an instantaneous speed of data flow from other peer client computers to a requesting client computer and determining a subset of other peer client computers that yield a highest measured speed of data flow.

39. A method of using a distributed file sharing system as claimed in claim 38 wherein the speed of data flow is measured by timing a responsiveness of a channel during a download.

40. A method of using a distributed file sharing system as claimed in claim 38 wherein the speed of data flow is measured by determining a number of intervening routers on a path.

41. A method of using a distributed file sharing system as claimed in claim 38 wherein the speed of data flow is measured by determining a cost as measured by Border Gateway Protocol routing tables.

42. A method of using a distributed file sharing system as claimed in claim 38 wherein the speed of data flow is determined by using pre-configured network topology maps.

43. A method of using a distributed file sharing system as claimed in claim 39 wherein said checksum of the reassembled file is computed using a MD5 checksum algorithm.

44. A method of using a distributed file sharing system as claimed in claim 39 wherein said checksum of the reassembled file is computed using a SHA1 checksum algorithm.

45. A method of using a distributed file sharing system as claimed in claim 39 wherein said checksum of the reassembled file is computed using a CRC checksum algorithm.

46. A method of using a distributed file sharing system as claimed in claim 43 further comprising the step of computing separate checksums for each part of the file received from other peer client computers when the comparison between the checksum of the reassembled file and the authentication code received from the server computer shows a discrepancy.

47. A method of using a distributed file sharing system as claimed in claim 46 further comprising the step of sending back to the server computer the separate checksums computed for each part of the file when the comparison between the checksum of the reassembled file and the authentication code received from the server computer shows a discrepancy.

48. A method of using a distributed file sharing system as claimed in claim 47 further comprising the steps of:
receiving from the server computer an updated list of locations of other client computers that presumably have the file, or a part of the file, when the comparison between the checksum of the reassembled file and the authentication code received from the server computer shows a discrepancy;
using said updated list of locations of other client computers to request and retrieve data pertaining to the file from client computers that actually have the file or a part of the file;
reassembling the file using the data received from the other client computers; and
computing a new checksum of a newly reassembled file and sending said new checksum to the server computer.

49. A method of providing a distributed file sharing system for fast download of data from multiple computer data storage mediums connected by peer-to-peer connections through a computer network, said method comprising the steps of:
receiving a request for a file from a requesting client computer connected to the computer network using a server computer;
sending a query for said file to a database connected to the server computer;
retrieving a list of locations of client computers that have the file or a part of the file and an authentication code from said database;
sending said list of locations of client computers and said authentication code back to the requesting client computer through the computer network.

50. A method of contributing with a serving client computer to a distributed file sharing system for fast download of data from multiple computer data storage mediums connected by peer-to-peer connections through a computer network, said method comprising the steps of:
receiving a request for a file from a requesting peer client computer connected to the computer network;
sending a query for said file to a database connected to the serving client computer;
retrieving information about the file from said database;
sending said information about the file back to the requesting peer client computer;
receiving a formal request from the requesting peer client computer for data from the file;
sending data from the file back to the requesting peer client computer.
